(19) United States
(12) Patent Application Publication
(10) Pub. No.: US 2018/0010788 A1
(43) Pub. Date: Jan. 11, 2018

(54) FLAMELESS THERMAL OXIDIZER AND RELATED METHOD OF SHAPING REACTION ZONE

(71) Applicants: Gene H. Irrgang, Horsham, PA (US); Eric Predatsch, Conshohocken, PA (US); Andrew Richardson, Clinton, NJ (US); Steve Korn, Northhampton, PA (US)

(72) Inventors: Gene H. Irrgang, Horsham, PA (US); Eric Predatsch, Conshohocken, PA (US); Andrew Richardson, Clinton, NJ (US); Steve Korn, Northhampton, PA (US)

(21) Appl. No.: 15/636,909

(22) Filed: Jun. 29, 2017

Related U.S. Application Data
(60) Provisional application No. 62/359,270, filed on Jul. 7, 2016.

(51) Int. Cl. F23C 99/00; F24J 1/00; B01J 8/00; B01J 8/02

(52) U.S. Cl. CPC F23C 99/006; B01J 8/02; F24J 1/00; B01J 8/008; B01J 2208/00796; B01L 2200/06; B01L 2200/028

(57) ABSTRACT

A flameless thermal oxidizer (FTO) includes at least one baffle constructed and arranged in a reaction chamber of the FTO to coact with a diptube of the FTO to radially expand a resulting “bubble” or reaction envelope from the diptube outward into a porous matrix of the FTO. A related method is also provided.

### BACKGROUND OF THE INVENTION

The present embodiments relate to baffles for a flameless thermal oxidizer (FTO), and a method of increasing capacity with the FTO.

Known FTOs have been used to maintain an oxidation reaction of gaseous waste stream(s) within a matrix of the FTO. However, such arrangements result in a limited flow capacity and limited reaction stability within the FTO. This is because the overcapacity reaction envelope or “reaction bubble” produced from the FTO diptube permits the incomplete oxidation reaction products to flow rapidly upward to and break or pierce through the top surface of the FTO matrix.

An example of a known FTO is shown in FIG. 1 and referenced generally as 10. The known FTO is a flameless matrix bed reactor which includes a vessel 12 or container in which a reaction chamber 14 is disposed. A porous matrix 16 is arranged in the reaction chamber 14, but does not completely fill the chamber. A diptube 18 extends into the reaction chamber 14 and into the porous matrix 16 for providing a reactable process stream 20 into the porous matrix 16. The oxidation product exhaust stack 22 is a continuation of the reaction space 14 above a surface 24 of the porous matrix 16.

In operation, the known FTO 10 receives the reactable process stream 20 in the diptube 18 whereupon the stream is exhausted from an outlet 26 of the diptube 18 into the porous matrix thereby creating a reaction bubble or reaction envelope 28.

However, the reaction bubble or reaction envelope 28 resulting from the stream will move vertically upward in the porous matrix 16 and along the diptube 18 and break or pierce the surface 24 of the matrix as turbulence shown generally at 30. This vertical movement or “short circuiting” occurs because there is no structure or method to impede or prevent such vertical movement.

What is therefore needed is an FTO that provides for a greater volume of the porous matrix 16 to be used which would result in a more stable reaction bubble or reaction envelope being created resulting in an increased capacity of the reactable process stream 20.

### SUMMARY OF INVENTION

There is therefore provided a flameless thermal oxidizer (FTO) embodiment having at least one baffle constructed and arranged in the reactive chamber of the FTO to coact with a diptube of the FTO to radially expand the resulting reaction bubble or reaction envelope from the diptube into the porous matrix.

A flameless thermal oxidizer (FTO) apparatus is provided and includes at least one baffle constructed and arranged in a reactive chamber of the FTO apparatus to coact with a diptube of the FTO apparatus to radially expand a resulting reaction envelope outward into a porous matrix of the FTO apparatus.

A related method to radially expand the reaction bubble in the porous matrix is also provided. A method of controlling a reaction envelope or reaction bubble in a porous matrix of an FTO, includes positioning at least one baffle in the porous matrix coacting with a diptube of the FTO, and interrupting upward flow of the reaction envelope or reaction bubble with the at least one baffle for radially expanding said reaction envelope or reaction bubble in said porous matrix.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a portion of a known FTO and the disposition of the reaction envelope in same;

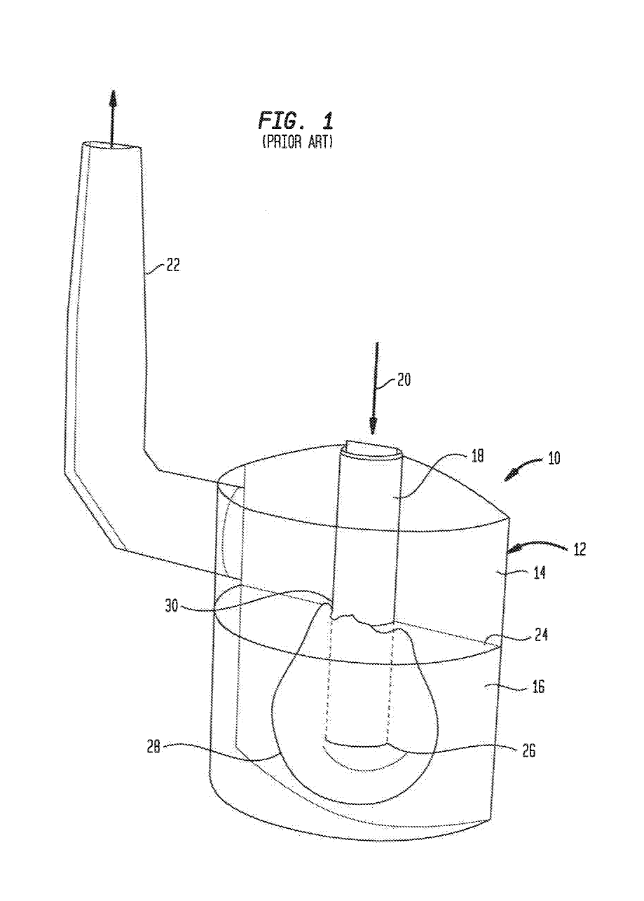

FIG. 2 shows an embodiment of a reaction chamber of an FTO having a baffle of the present embodiments;

FIG. 3 shows another embodiment of a baffle apparatus for an FTO; and

FIG. 4 shows still another embodiment of a baffle apparatus for an FTO.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity, illustrating the invention and should not be taken as words of limitation. The drawings are for the purpose of illustrating the invention and are not intended to be to scale.

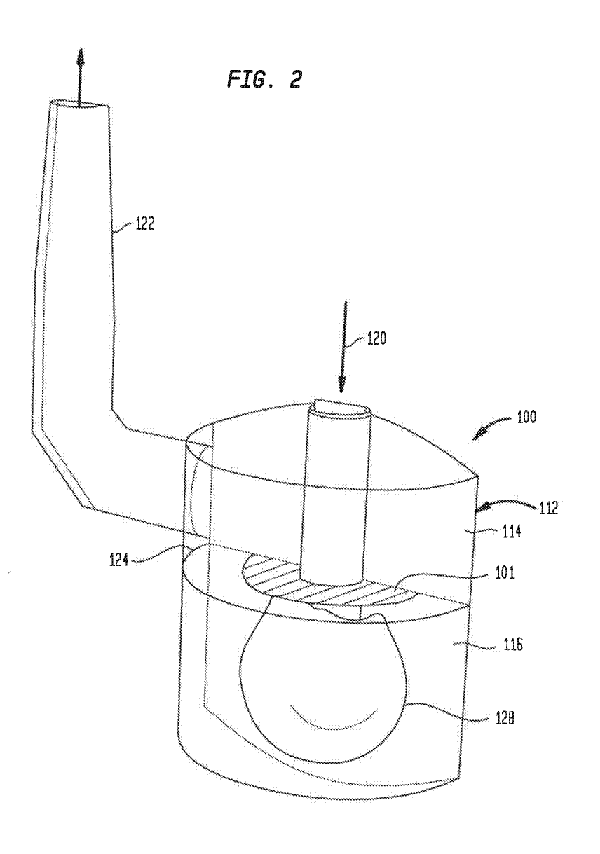

In general, and in an FTO of the present embodiments beginning at FIG. 2, the introduction of impermeable or semi-permeable baffles surrounding the diptube of the FTO between an upper surface of a porous matrix and a discharge of the diptube is shown. The baffles are arranged to inhibit or prevent a vertical movement (known as “short circuiting”) of gases exiting the diptube and subsequent reaction products around an exterior of the diptube. By “impermeable” it is meant that the material and construction of the baffle is such that no gas may pass through the baffle. The meaning of “semi-permeable” as used herein means that a portion of gas may pass through the baffle. The terms “reaction envelope” and “reaction bubble” can be used herein interchangeably.

Referring to FIG. 2, a first embodiment of an FTO is shown generally at 100, and includes a baffle 101 at or proximate a surface 124 of a porous matrix 116 disposed in a reaction chamber 114 of the FTO. As shown in the embodiment of FIG. 2, the baffle 101 can be constructed from impermeable or semi-permeable material. The baffle 101 substantially reduces if not eliminates short circuiting of the reaction bubble 128 so that same expands with an increased residence time within the porous matrix 116. Disruptive turbulence at the surface 124 is avoided. Due to the perspective view of the embodiment in FIG. 2, approximately one-half of the baffle 101 is shown, but it is understood that a remaining portion of the baffle extends a corresponding amount at or proximate the surface of the porous matrix 116.

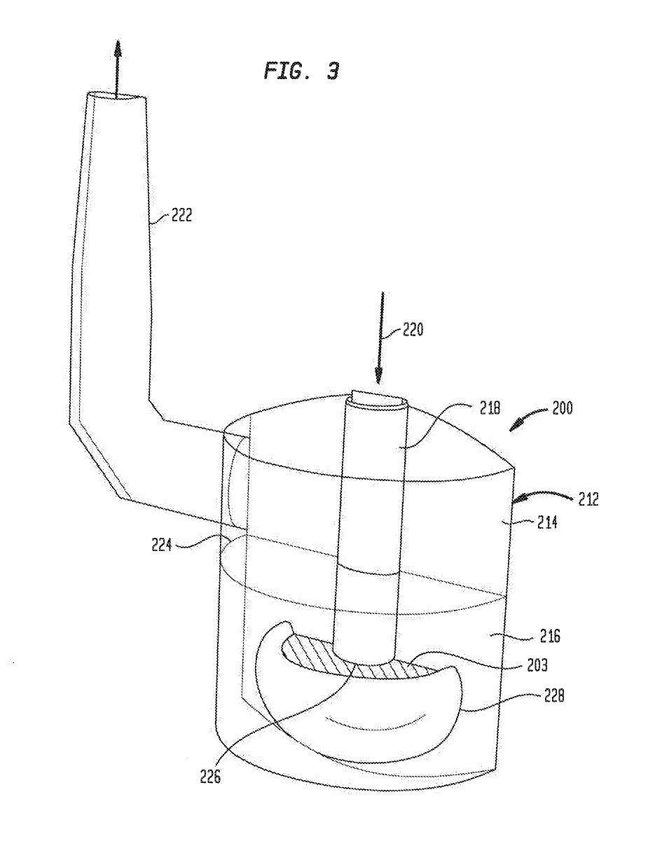

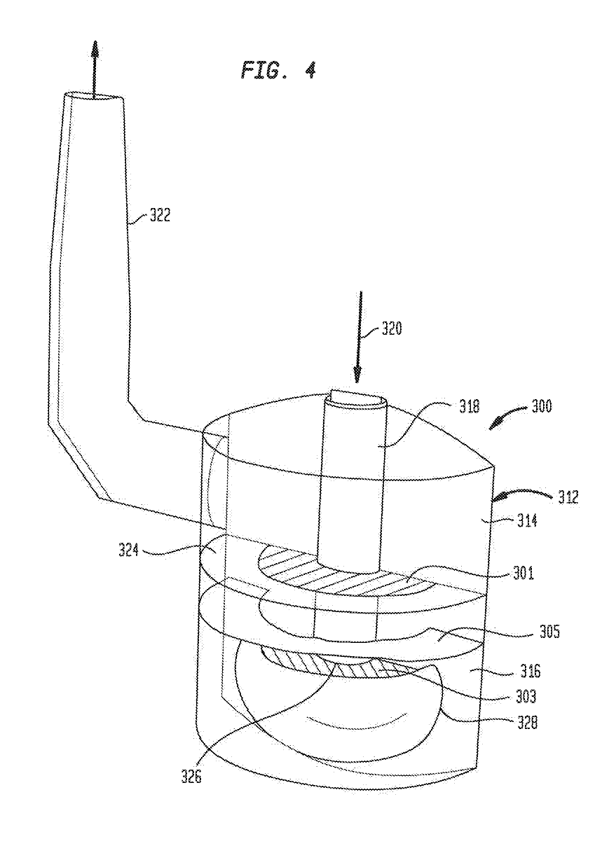

Two other exemplary embodiments of an FTO constructed in accordance with the present invention are illustrated in FIGS. 3-4, respectively. Elements illustrated in FIGS. 3-4 which correspond to the elements described above with respect to FIG. 2 had been designated by corresponding reference numerals increased by 200 and 300, respectively. The embodiments of FIGS. 3-4 are designed for use in this same manner as the embodiment of FIG. 2 unless otherwise stated.

Referring to FIG. 3, another embodiment of an FTO is shown generally at 200, and includes a baffle 203 at or proximate an outlet 226 of a diptube 218 in a porous matrix 216 in the reaction chamber 214 of the FTO. As shown in the embodiment of FIG. 3, the baffle 203 can be constructed from impermeable or semi-permeable material. The baffle 203 substantially reduces if not eliminates short circuiting of the reaction bubble 228 so that same expands with an increased residence time within the porous matrix 216. Disruptive turbulence at the surface 224 is avoided. Due to the perspective view of the embodiment in FIG. 3, approximately one-half of the baffle 203 is shown, but it is understood that a remaining portion of the baffle extends a corresponding amount at or through the porous matrix.

Referring to FIG. 4, still another embodiment of an FTO is shown generally at 300, and includes a baffle 301 at or proximate a surface 324 of a porous matrix 316 disposed in the reaction chamber 314 of the FTO. As also shown in FIG. 4, there is included a baffle 303 at or proximate an outlet 326 of a diptube 318 in a porous matrix 316 at the reaction chamber 314 of the FTO. As shown in FIG. 4, the baffles 301,303 can be constructed from impermeable or semi-permeable material. The baffles 301, 303 substantially reduce if not eliminate short circuiting of the reaction bubble 328 so that same expands with an increased residence time within the porous matrix 316. The embodiment of FIG. 4 may also includes a central baffle 305 positioned in the porous matrix 316 between the baffle 301 (upper) and the baffle 303 (lower). The central baffle 305 may also be constructed from impermeable or semi-permeable material. The use of the central baffle 305 provides for a more sinuous or circuitous path for constituents to travel through the porous matrix 316 from the reaction bubble 328. Due to the perspective view of the embodiment in FIG. 4, approximately one-half of the baffles 301, 303 and 305 are shown, but it is understood that the remaining portions of these baffles extend a corresponding amount along the porous matrix.

By inhibiting the immediate vertical movement of the gases and combustion products from the reaction bubbles 128, 228 328, the flow from the diptubes 120, 220, 320 is forced to move radially outwards and expand, as well as move downward. Such an expanding flow field not only avoids the “short circuiting” discussed above, but also i) causes a greater volume of the porous matrix 116, 216, 316 to be utilized, and ii) provides a more stable reaction bubble 128, 228, 328 to form at higher flow capacities within the matrix.

FIGS. 2-4 show internal baffle apparatus for the FTOs 100, 200 and 300 and related methods according to the present embodiments. Each one of the apparatus and method embodiments shown in FIGS. 2-4 provide alternate ways in which baffles may be employed at an interior of an FTO to better control reaction within same and provide for a more efficient processing of the reactable process stream 120, 220, 320.

The justification for providing a more stable reaction bubble at higher volumes of reactable process streams being provided to the FTOs 100, 200, 300 is as follows.

Referring to the embodiment of FIG. 2 by way of example only, a surface of the reaction bubble is determined by “knitting together local locations”, wherein the combustion reaction takes place to form a combustion envelope or reaction bubble. Within the reaction envelope (or reaction bubble), there are predominantly reactants, while external or outside the envelope there are predominantly products. “Predominantly” herein means that while the combustion reactions are fast, such reactions do take a certain amount of time and therefore, external to and proximate the envelope there are varying degrees of combustion completeness.

The local oxidation reaction occurs where the local reaction speed (the speed at which the reaction would propagate into a quiescent mixture of the same composition, pressure and temperature) matches the local flow velocities, i.e. the speed of the gas moving through the matrix. When these two speeds (the reaction speed and the gas velocity) match, the location of the combustion reaction is fixed in position and therefore, a stable reaction envelope or “reaction bubble” is formed.

Forcing the flow from the diptube outlet (e.g. 226) outwards in a radial/downward direction causes the flow to decelerate in a direction away from the diptube, and the reaction envelope or reaction bubble will form at a certain distance from the diptube. Furthermore, with an increasing flow rate the “reaction bubble” may be expected to move radially outwards until the velocity is reduced to again match the reaction speed.

The absence of a submerged baffle 203, 303 proximate an outlet of the submerged diptube 218, 318 results in the combustion gases being distributed into a flow path that minimizes the pressure drop through the porous matrix. A significant portion of the combustion gas therefore flows in the shortest path immediately up and around the diptube. This means that the gases do not all flow significantly radially/downward and accordingly, there is the propensity for the uncombusted gases to well-up around the diptube prior to the reaction bubble or reaction envelope growing to occupy a significant portion of the vessel or bed diameter. Use of the baffles 203, 303 prevents such occurrence.

The placement of a baffle above and also surrounding the discharge outlet of the diptube forces the gases to move radially outwards, also to disperse downwards to form the three-dimensional (“3-D”) curved surface without moving vertically. This allows the reaction bubble to form at greater radii prior to breakthrough at the bed surface. The effect on stability and capacity is magnified as the local flow velocity will vary inversely proportionally to the square of the radial distance from the diptube. Thus, a change in overall flow or composition at high flow rates can be accommodated by only a small movement in the reaction bubble.

In the current embodiments of FIGS. 2-4, the mixed gases exiting or being exhausted from the diptube outlet will distribute into the matrix 116, 216, 316 according to pressure drop. The lowest pressure path is along the circumference of the diptube. Because the reaction zone is defined as the point where the velocity of the gas is equal to the reverse velocity of the reaction, the controlling velocity is that of the gases along the diptube. The present embodiments provide that the shape of the reaction zone is an ellipsoid, when in fact it resembles a tear drop. The design flow rates provided by the present calculation based on the ellipsoid provide a breakthrough of partially combusted gases around the diptube that limits the capacity of the system. In an installation where the vessel 112 size is 22′ in diameter, a baffle was installed at the top of the bed to prevent the breakthrough.

The impact on capacity was not a concern and therefore not quantified or accounted for. During CFD study examples to determine baffle placement in the reaction chamber, alternate baffle placement was considered only as related to minimizing breakthrough. Examples included a 12′ diameter FTO, with no baffle, an upper baffle (two different diameters) and a lower baffle. The upper baffle achieved the same results as with the current operating unit with respect to restricting the reaction within the matrix. The lower baffle also accomplished the same result, but provided an additional advantage of increasing the capacity on the order of 250% to 300%, ie. 6 MM Btu/hr as taught by the current embodiment to 15 MM Btu/hr.

It will be understood that the embodiments described herein are merely exemplary, and that a person skilled in the art may make variations and modifications without departing from the spirit and scope of the invention. All such variations and modifications are intended to be included within the scope of the invention as provided and claimed herein. It should be understood that the embodiments described above are not only in the alternative, but can be combined.

What is claimed is:

1. A flameless thermal oxidizer (FTO), comprising:
at least one baffle constructed and arranged in a reactive chamber of the FTO to coact with a diptube of the FTO to radiate and expand a resulting reaction envelope from the diptube outward into a porous matrix of the FTO.

2. The FTO of claim 1, wherein the at least one baffle is constructed from a material selected from the group consisting of an impermeable material, and a semi-permeable material.

3. The FTO of claim 1, wherein the at least one baffle is positioned in the reactive chamber at a surface of the porous matrix.

4. The FTO of claim 1, wherein the reaction envelope comprises a bubble shape beneath the at least one baffle.

5. The FTO of claim 1, wherein the at least one baffle extends across a substantial portion of a surface area of the porous matrix.

6. The FTO of claim 1, wherein the at least one baffle is positioned in the reactive chamber below a surface of the porous matrix.

7. The FTO of claim 6, wherein the at least one baffle is positioned closer to an outlet of the diptube than the surface of the porous mixture.

8. The FTO of claim 6, wherein the at least one baffle is constructed from a material selected from the group consisting of an impermeable material, and a semi-permeable material.

9. The FTO of claim 1, wherein the at least one baffle is an upper baffle positioned in the reactive chamber at a surface of the porous matrix, and further comprising a lower baffle positioned in the reactive chamber below the surface of the porous mixture and spaced apart from the upper baffle.

10. The FTO of claim 9, wherein the upper and lower baffles each comprise similar shapes and have similar surface areas.

11. The FTO of claim 10, wherein the upper and lower baffles are each constructed from a material selected from the group consisting of an impermeable material and a semi-permeable material.

12. The FTO of claim 9, wherein the positioning of the upper and lower baffles in the spaced apart relation in the porous matrix provides increased residence time and a variable expanding flow path for the reaction envelope in the porous matrix.

13. The FTO of claim 9, further comprising a central baffle positioned in the porous matrix between and spaced apart from each of the upper baffle and the lower baffle.

14. The FTO of claim 13, wherein the upper, lower and central baffles each have a different size and surface area.

15. A method of controlling a reaction envelope in a porous matrix of a flameless thermal oxidizer (FTO), comprising:
positioning at least one baffle in the porous matrix for coacting with the reaction envelope emitted from a diptube of the FTO; and
interrupting upward flow of the reaction envelope with the at least one baffle for radially expanding said reaction envelope in said porous matrix.

16. The method of claim 15, wherein the reaction envelope is bubble-shaped.

17. The method of claim 15, wherein the expanding occurs in the porous matrix beneath the at least one baffle.

18. The method of claim 17, wherein the expanding of the reaction envelope provides increasing a residence time of the reaction envelope in the porous matrix after being emitted from the diptube.

19. The method of claim 15, wherein the positioning of the at least one baffle is at a surface of the porous matrix.

20. The method of claim 15, further comprising providing a second baffle in the porous matrix below and spaced apart from the at least one baffle.

21. The method of claim 20, wherein the providing of the second baffle is closer to an outlet of the diptube then to the at least one baffle.

22. The method of claim 20, further comprising providing a third baffle in the porous matrix between and spaced apart from the at least one baffle and the second baffle.

23. The method of claim 22, wherein the least one, second and third baffles provide a flow path varying and increasing residence time of the reaction envelope in the porous matrix.

24. The method of claim 15, wherein the radially expanding the reaction envelope comprises downward movement of said reaction envelope in the porous matrix.
